(19) United States
(12) Patent Application Publication
(10) Pub. No.: US 2003/0214605 A1
(43) Pub. Date: Nov. 20, 2003

(54) Autokeying method, system, and computer program product

(76) Inventors: Robert J. Snyder, Jacksonville, FL (US); Alex Holtz, Jacksonville, FL (US); John R. Benson, Jacksonville, FL (US); William H. Couch, Fernandina Beach, FL (US); Marcel LaRocque, Jacksonville, FL (US); Maurice Smith, Jacksonville, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/434,460

(22) Filed: May 9, 2003

Related U.S. Application Data
(63) Continuation-in-part of application No. 10/208,810, filed on Aug. 1, 2002.
(63) Continuation-in-part of application No. 09/836,239, filed on Apr. 18, 2001.
(63) Continuation-in-part of application No. 09/634,735, filed on Aug. 8, 2000.
(63) Continuation-in-part of application No. 09/488,578, filed on Jan. 21, 2000.
(63) Continuation-in-part of application No. 09/482,683, filed on Jan. 14, 2000.
(63) Continuation-in-part of application No. 09/215,161, filed on Dec. 18, 1998, now Pat. No. 6,452,612.
(63) Continuation-in-part of application No. 09/822,855, filed on Apr. 2, 2001.
(63) Continuation-in-part of application No. 09/832,923, filed on Apr. 12, 2001.
(63) Continuation-in-part of application No. 10/247,783, filed on Sep. 20, 2002.
(60) Provisional application No. 60/378,671, filed on May 9, 2002.
(60) Provisional application No. 60/386,753, filed on Jun. 10, 2002.
(60) Provisional application No. 60/309,788, filed on Aug. 6, 2001.
(60) Provisional application No. 60/193,452, filed on Mar. 31, 2000.
(60) Provisional application No. 60/196,471, filed on Apr. 12, 2000.
(60) Provisional application No. 60/363,098, filed on Mar. 12, 2002.
(60) Provisional application No. 60/323,328, filed on Sep. 20, 2001.
(60) Provisional application No. 60/378,655, filed on May 9, 2002.
(60) Provisional application No. 60/378,656, filed on May 9, 2002.
(60) Provisional application No. 60/378,657, filed on May 9, 2002.
(60) Provisional application No. 60/378,672, filed on May 9, 2002.

(51) Int. Cl. H04N 9/74

(52) U.S. Cl. 348/578; 348/584

(57) ABSTRACT

Parallel automated keying allows multiple media productions to be keyed and outputted to a program or preview channel. An automation control system monitors and updates the operating states of a plurality of automated keyers, which support manual or automated production environments. A user interface allows a director, or other personnel, to set key attributes by selecting input sources for a background media production, a fill, and a key associated with the fill source. The operating states are monitored to select an unoccupied keyer. The three sources are selected and routed to the unoccupied keyer, which composites the sources on preview. Afterwards, the director steps or transitions the composite media production from preview to program. As a result, the director is not required to know which keyer is being used on-air to determine which keyer is available for a program channel.

### CROSS-REFERENCE TO RELATED APPLICATIONS

This application claims the benefit of U.S. Provisional Application No. 60/378,671, filed May 9, 2002, entitled “Automated Keying Method, System, and Computer Program Product,” incorporated herein by reference in its entirety.

This application is a continuation-in-part of U.S. application Ser. No. 10/208,810, filed Aug. 1, 2002, by Holtz et al., entitled “Method, System, and Computer Program Product for Producing and Distributing Enhanced Media,” incorporated herein by reference in its entirety; which claims the benefit of U.S. Provisional Application No. 60/386,753, filed Jun. 10, 2002, by Holtz et al., entitled “Method, System and Computer Program Product for Producing and Distributing Enhanced Media,” incorporated herein by reference in its entirety; as well as the benefit of U.S. Provisional Application No. 60/309,788, filed Aug. 6, 2001 (now abandoned), by Holtz, entitled “Webcasting and Business Models,” incorporated herein by reference in its entirety.

This application is a continuation-in-part of U.S. application Ser. No. 09/836,239, filed Apr. 18, 2001, by Holtz et al, entitled “Method, System and Computer Program Product for Producing and Distributing Enhanced Media Downstreams,” incorporated herein by reference in its entirety.

This application is a continuation-in-part of U.S. application Ser. No. 09/634,735, filed Aug. 8, 2000, by Snyder et al., entitled “System and Method for Real Time Video Production and Multicasting,” incorporated herein by reference in its entirety; which is a continuation-in-part of U.S. application Ser. No. 09/488,578, filed Jan. 21, 2000, by Snyder et al., entitled “System and Method for Real Time Video Production and Multicasting,” incorporated herein by reference in its entirety; which is a continuation-in-part of U.S. application Ser. No. 09/482,683, filed Jan. 14, 2000, by Holtz et al., entitled “System and Method for Real Time Video Production and Multicasting,” incorporated herein by reference in its entirety; which is a continuation-in-part of U.S. application Ser. No. 09/215,161, filed Dec. 18, 1998 (now U.S. Pat. No. 6,452,612), by Holtz et al., incorporated by reference in its entirety.

This application is a continuation-in-part of U.S. application Ser. No. 09/822,855, filed Apr. 2, 2001, by Holtz et al., entitled “Method, System and Computer Program Product for Full News Integration and Automation in a Real Time Video Production Environment,” incorporated herein by reference in its entirety; which claims the benefit of U.S. Provisional Application No. 60/193,452, filed Mar. 31, 2000 (now abandoned), by Holtz et al., entitled “Full News Integration and Automation for a Real time Video Production System and Method,” incorporated herein by reference in its entirety.

This application is a continuation-in-part of U.S. application Ser. No. 09/832,923, filed Apr. 12, 2001, by Holtz et al., entitled “Interactive Tutorial Method, System and Computer Program Product for Real Time Media Production,” incorporated herein by reference in its entirety; which claims the benefit of U.S. Provisional Application No. 60/196,471, filed Apr. 12, 2000 (now abandoned), by Holtz et al., entitled “Interactive Tutorial System, Method and Computer Program Product for Real Time Video Production,” incorporated herein by reference in its entirety.

This application is a continuation-in-part of U.S. application Ser. No. 10/247,783, filed Sep. 20, 2002, by Holtz et al., entitled “Advertisement Management Method, System, and Computer Program Product,” incorporated herein by reference in its entirety; which claims the benefit of U.S. Provisional Application No. 60/363,098, by Holtz, filed Mar. 12, 2002 (now abandoned), entitled “Sales Module to Support System for On-Demand Internet Deliver of News Content,” incorporated herein by reference in its entirety; as well as the benefit of U.S. Provisional Application No. 60/323,328, by Holtz, filed Sep. 20, 2001 (now abandoned), entitled “Advertisement Management Method, System, and Computer Program Product,” incorporated herein by reference in its entirety.

This application claims the benefit of U.S. Provisional Application No. 60/378,655, filed May 9, 2002, by Holtz et al., entitled “Enhanced Timeline,” incorporated herein by reference in its entirety; U.S. Provisional Application No. 60/378,656, filed May 9, 2002, by Holtz et al., entitled “Director's Interface,” incorporated herein by reference in its entirety; U.S. Provisional Application No. 60/378,657, filed May 9, 2002, by Holtz, entitled “Automated Real-Time Execution of Live Inserts of Repurposed Stored Content Distribution,” incorporated herein by reference in its entirety; and U.S. Provisional Application No. 60/378,672, filed May 9, 2002, by Holtz, entitled “Multiple Aspect Ratio Automated Simulcast Production,” incorporated herein by reference in its entirety.

The following United States and PCT utility patent applications have a common assignee and contain some common disclosure:

“System and Method For Real Time Video Production and Multicasting,” PCT Patent Application No. PCT/US01/00547, by Snyder et al., filed Jan. 9, 2001, incorporated herein by reference in its entirety;

“Method, System and Computer Program Product for Full News Integration and Automation in a Real Time Video Production Environment,” PCT Patent Application No. PCT/US01/10306, by Holtz et al., filed Apr. 2, 2001, incorporated herein by reference in its entirety;

“Real Time Video Production System and Method,” U.S. application Ser. No. 10/121,608, filed Apr. 15, 2002, by Holtz et al., incorporated herein by reference in its entirety;

“Method, System and Computer Program Product for Producing and Distributing Enhanced Media Downstreams,” PCT Patent Application No. PCT/US02/12048, by Holtz et al., filed Apr. 17, 2002, incorporated herein by reference in its entirety;

“Playlist for Real Time Video Production,” U.S. application Ser. No. 10/191,467, filed Jul. 10, 2002, by Holtz et al., incorporated herein by reference in its entirety;

“Real Time Video Production System and Method,” U.S. application Ser. No. 10/200,776, filed Jul. 24, 2002, by Holtz et al., incorporated herein by reference in its entirety;

“Method, System and Computer Program Product for Producing and Distributing Enhanced Media,” PCT Patent Application No. PCT/US02/24929, by Holtz et al., filed Aug. 6, 2002, incorporated herein by reference in its entirety;

“Advertisement Management Method, System, and Computer Program Product,” PCT Patent Application No. PCT/US02/29647, filed Sep. 20, 2002, by Holtz et al., incorporated herein by reference in its entirety; and

“Building Macro Elements for Production Automation Control,” U.S. application Ser No. TBD (Attorney Docket No. 1752.0540000), filed TBD, by Snyder et al., incorporated herein by reference in its entirety.

### BACKGROUND OF THE INVENTION

1. Field of the Invention

The present invention relates generally to media production, and more specifically, to keying a video production.

2. Related Art

Video keying enables two video sources to be combined into a composite video image by selectively switching between the two sources. A video keyer switches between the two sources in accordance with a switching signal. The switching signal, however, is derived from a video source rather than a fixed pattern generator. An internal key typically uses a luminance level of the video to create the switch. This is practical for superimposing black-and-white graphics or text onto the video.

Multiple types of video keyers can be found. For example, luminance keyers and chroma keyers represent two commonly known keyers. For luminance or chroma keyers, a monochrome key signal is used to determine when to switch. These simple keyers switch between two sources based on the level of the key signal in relation to key level and/or clip controls. The key signal can be derived from an overall brightness level (i.e., luminance key), color or hue information (i.e., chroma key), or a combination of both.

Another type of keyer is a linear keyer. Linear keyers provide a full range of transparency, which allows natural and pleasing compositing of images. With a linear keyer, the key signal is used to effectively dissolve between two video sources, one representing a background image and the other representing a foreground image. If the value of the key signal is zero or black, the foreground image is completely transparent and thus cannot be seen over the background image. If the key signal has the absolute value of one-hundred units or white, the foreground image is completely opaque and thus the background image cannot be seen under the foreground image. For key signal values between zero and one hundred, the foreground image achieves an increasing degree of translucence as the key signal approaches the absolute value. Accordingly, the background image becomes less visible through the foreground image as the absolute value of the key signal is approached. An advantage of using a linear keyer is that it can maintain the proper levels of anti-aliased images (especially graphics) when creating a composite image.

In a news broadcast environment, keyers are used to create lower thirds on a video shot. As such, graphic titles are retrieved from a character generator, and located or “keyed” at the lower third portion of a television screen. In addition, keyers are used to create “over-the-shoulder” (OTS) boxes. OTS boxes can be used to enhance the presentation of an on-camera shot of the news anchor by highlighting a graphic, picture, or text to support the topic being discussed.

To create a composite view having the lower third and/or OTS as described in the previous example, a director for a newscast would setup a keyer on a “mixed effect” bank (M/E). First, the director would select an “unoccupied” keyer that would receive video input from the camera that is recording the news anchor. This video input would serve as the background video. The director would then select the desired graphic title and/or an OTS video source that would be used as the foreground image. The director would also specify the desired location for placing the graphic title and/or OTS over the background video.

After the keyer has been setup on M/E, the director would preview the composite view (i.e., the key shot with the lower third or OTS) to check for accuracy. Once the director is satisfied with the result, the composite or keyed shot is transitioned to air on a program channel. If another keyed shot is required, the director must select another unoccupied keyer, follow the same process from M/E, to preview, to air on the program channel.

As can be seen in a live production environment, the director must keep track of the keyers to avoid on-air mistakes. In other words, the director must be able to quickly determine which keyers are keying content for air, which ones are keying content for a preview channel, and which ones are unoccupied. In a complex newscast, many keyed shots are produced in a short time span, and most of the keyed shots occur back-to-back. Thus, it is extremely challenging for a director to accurately and quickly identify which keyer(s) on which M/E bank are on-air and which ones have already been setup in preview.

Therefore, a need exists to develop a technology that addresses these concerns thereby simplifying the keying process.

### SUMMARY OF THE INVENTION

A method, system and computer program product are provided to implement parallel automated keying for one or more media productions (such as, news programs, situation comedies, concerts, movies, video rentals, radio broadcast, animation, etc.). A plurality of automated keyers are programmable to key one or more layers on a media production. Hence, multiple keyers are serially positioned to composite multiple keyer layers. Additionally, two or more keyers are positioned to composite productions for output on two separate channels, such as a program channel or a preview channel.

In an embodiment, the automated keyers are placed in a fixed arrangement comprising two groups. A first group of keyers are serially positioned to support multiple keyer layers. The total number of automated keyers placed in series depends on the maximum number of keyer layers established for the keyer system. A second group of keyers are placed in parallel to support multiple outputs. The total number of parallel keyers placed depends on the maximum number of channels established for the keyer system.

In another embodiment, an automated router comprises a plurality of automated keyers. The automated router is responsive to control signals that instruct the automated keyers to float. By floating, the automated keyers are programmable to be grouped in serial and parallel variable arrangements and assigned to multiple flow paths to output composite productions to multiple channels (e.g., program and preview). For example, the automated router can be instructed to allow two keyer layers to be composited and transitioned between a preview and program channel. In another example, the automated router is instructed to route a video shot having no keyer layers, a single keyer layer, or multiple keyer layers.

A user interface allows a director, or other personnel, to configure the attributes or properties for the key effects. Accordingly, the director specifies a background media source, a fill source, and a key source. By specifying the background media source, the director identifies a media production that will be keyed according to the present invention. The fill source specifies a device and/or file for the content that will be keyed on the background media production. The key source is associated with the fill source and specifies the shape and position of the key fill on the background media production. The three sources are recorded to a configuration file.

In an embodiment, one or more automation control icons are placed on a graphical user interface to configure the key effects. As such, the director operates an input device to open an automation control icon that produces a dialogue box. The dialog box is responsive to receiving the background, fill, and key information. The automation control icon is associated with a set of computer readable broadcast instructions. When the automation control icon is activated by a timer associated with the user interface, the associated broadcast instructions are executed to transmit commands to an automated keyer that implements the key effects. In an embodiment, the broadcast instructions are created from the Transition Macro™ multimedia production control program developed by ParkerVision, Inc. (Jacksonville, Fla.) that can be executed to control an automated multimedia production system. The Transition Macro™ program is described in the pending U.S. application entitled “System and Method for Real Time Video Production and Multicasting” (U.S. application Ser. No. 09/634,735), which is incorporated herein by reference as though set forth in its entirety.

The automated keyers of the present invention can be implemented in a manual media production environment as well as an automated media production environment. An automated multimedia production environment includes a media production processing device that automatically or semi-automatically commands and controls the operation of a variety of media production devices, including an automated keyer. Therefore in an embodiment, the media production processing device sends control signals to the automated router to implement the serial and parallel variable arrangements and assigned flow paths, as previously discussed.

The present invention also includes a system and method for monitoring, updating, and altering the operating states of the automated keyers. The operating states are monitored to determine if a keyer is currently keying content for a program channel, keying content for a preview channel, or unoccupied. Hence prior to implementing the key effects from the configuration file, the operating states are monitored to select an unoccupied keyer. In an embodiment using an automation control icon, when the icon is activated, the associated broadcast instructions call or implement a routine to automatically select an automated keyer. Afterwards, keyer control commands are transmitted to send the configuration data (i.e., background, fill, and key source) to the selected keyer to composite the predefined key effects.

In an embodiment, only an unoccupied keyer is selected. However in another embodiment, a keyer operating in a preview state is chosen if no unoccupied keyers are currently available. The present invention includes mechanisms that allow a director to approve or reject the selection of a keyer before the keyer is placed in operation.

Therefore, the present invention provides methodologies and/or techniques for automatically selecting a keyer and compositing predefined keyer layer(s). The composite media production is routed over a preview channel so that the director can review the production. If the key effects are approved, the director steps or transitions the composite media production from preview to program. As a result, the director is not required to keep track of the keyer operating states when keying and reviewing a media production during a live production.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable one skilled in the pertinent art(s) to make and use the invention. In the drawings, generally, like reference numbers indicate identical or functionally or structurally similar elements. Additionally, generally, the leftmost digit(s) of a reference number identifies the drawing in which the reference number first appears.

FIG. 1 illustrates an operational flow for keying a media production according to an embodiment of the present invention.

FIG. 2 illustrates an operational flow for identifying and selecting a keyer according to an embodiment of the present invention.

FIG. 3 illustrates an operational flow diagram for identifying and selecting a keyer according to another embodiment of the present invention.

FIG. 4 illustrates an operational flow diagram for identifying and selecting a keyer according to another embodiment of the present invention.

FIG. 5a illustrates an initial state of two keyers according to an embodiment of the present invention.

FIG. 5b illustrates a queue for two unoccupied keyers according to an embodiment of the present invention.

FIG. 5c. illustrates program and preview states of two keyers according to an embodiment of the present invention.

FIG. 6a illustrates an initial state of three keyers according to an embodiment of the present invention.

FIG. 6b illustrates a queue for three unoccupied keyers according to an embodiment of the present invention.

FIG. 6c illustrates program and preview states of keyers according to another embodiment of the present invention.

FIG. 6d illustrates program and preview states of keyers according to another embodiment of the present invention.

FIG. 7a illustrates an initial state of a plurality of keyers according to an embodiment of the present invention.

FIG. 7b illustrates a queue for a plurality of keyers according to an embodiment of the present invention.

FIG. 7c illustrates a program state of keyers according to an embodiment of the present invention.

FIG. 7d illustrates a preview state of keyers according to an embodiment of the present invention.

FIG. 7e illustrates an unoccupied state of keyers according to an embodiment of the present invention.

FIG. 8 illustrates a keyer system according to an embodiment of the present invention.

FIG. 9 illustrates a keyer system according to another embodiment of the present invention.

FIG. 10 illustrates an example computer system useful for implementing portions of the present invention.

FIG. 11 illustrates a user interface for a show rundown according to an embodiment of the present invention.

FIG. 12 illustrates a user interface for keying a media production according to an embodiment of the present invention.

FIG. 13 illustrates a video image keyed according to an embodiment of the present invention.

FIG. 14 illustrates a display for a quad box application according to an embodiment of the present invention.

### DETAILED DESCRIPTION OF THE INVENTION

The present invention comprises various techniques and/or methodologies for monitoring, altering, and updating the operating state of a plurality of keying systems. The operating state determines, inter alias, if a keying system is currently keying content for air, keying content for preview, or not keying content. If a keying system is not keying content, the keying system is deemed to be “unoccupied” and available for use.

The present invention further describes techniques and/or methodologies for automatically selecting a keyer to key layers on a media production. As used herein, the term “media production” includes the production of any and all forms of media or multimedia in accordance with the method, system, and computer program product of the present invention. A media production includes, but is not limited to, video of news programs, television programming (such as, documentaries, situation comedies, dramas, variety shows, interviews, or the like), sporting events, concerts, infomercials, movies, video rentals, or any other content. For example, a media production can include streaming video related to corporate communications and training, educational distance learning, or home shopping video-based “e” or “t” commerce. Media productions also include live or recorded audio (including radio broadcast), graphics, animation, computer generated, text, and other forms of media and multimedia.

Accordingly, a media production can be live, as-live, or live-to-tape. In a “live broadcast” embodiment of the present invention, a media production is recorded and immediately broadcast over traditional airwaves or other mediums (e.g., cable, satellite, etc.) to a television or the like. At the same time (or substantially the same time), the media production can be encoded for distribution over a computer network. In an embodiment, the computer network includes the Internet, and the media production is formatted in hypertext markup language (HTML), or the like, for distribution over the World Wide Web. However, the present invention is not limited to the Internet. A system and method for synchronizing and transmitting traditional and network distributions are described in the pending U.S. application entitled “Method, System, and Computer Program Product for Producing and Distributing Enhanced Media” (U.S. application Ser. No. 10/208,810), which is incorporated herein by reference in its entirety.

The term “as-live” refers to a live media production that has been recorded for a delayed broadcast over traditional or network mediums. The delay period is typically a matter of seconds and is based on a number of factors. For example, a live broadcast may be delayed to grant an editor sufficient time to approve the content or edit the content to remove objectionable subject matter.

The term “live-to-tape” refers to a live media production that has been stored to any type of record playback device (RPD), including a video tape recorder/player (VTR), video recorder/server, virtual recorder (VR), digital audio tape (DAT) recorder, or any mechanism that stores, records, generates, or plays back via magnetic, optical, electronic, or any other storage media. It should be understood that “live-to-tape” represents only one embodiment of the present invention. The present invention is equally applicable to any other type of production that uses or does not use live talent (such as cartoons, computer-generated characters, animation, etc.). Accordingly, reference herein to “live,” “as-live,” or “live-to-tape” is made for illustration purposes, and is not limiting. Additionally, traditional or network distributions can be live or repurposed from previously stored media productions.

As discussed above, the present invention provides methods for keying a media production for distribution over traditional or network mediums. The keyed media production can also be saved to a storage medium for subsequent retrieval. In an embodiment, parallel automated keyers are used to allow multiple media productions to be keyed and outputted to a program or preview channel. The operating state is monitored, updated, and altered to simplify the keyer operations and thereby reduce the burden on the video director, so that the director can focus attention on the “on-air” product. In other words, the present invention enables a director, or other personnel, to select a key to preview before the key appears in a program channel when a transition occurs. The director no longer has to determine which keyer is being used on-air to determine which keyer is available for the program channel.

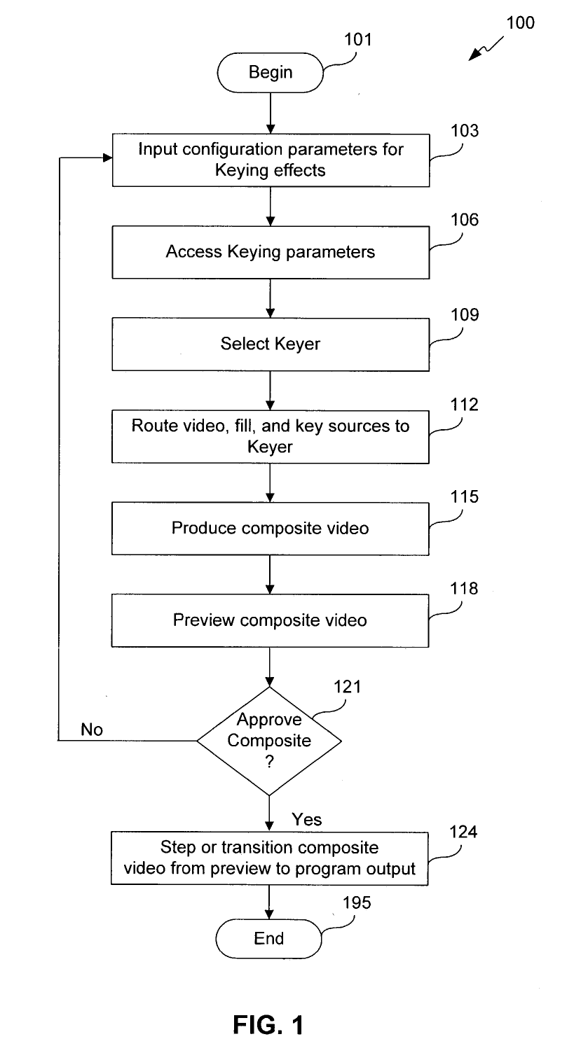

Referring to FIG. 1, flowchart 100 represents the general operational flow of an embodiment of the present invention. More specifically, flowchart 100 shows an example of a control flow for automating parallel keyers according to the present invention. In other words, the control flow provides an example of compositing one or more keys or keyer layers on two or more media productions at the same time.

The control flow of flowchart 100 begins at step 101 and passes immediately to step 103. At step 103, a director, another crew member, or the like establishes the configuration parameters for the automated keying system. As described in greater detail below, an automated keying system comprises one or more keyers, which can be internal or external to a media production switcher. The keyers can be luma keyers, chroma keyers, linear keyers, or any combination thereof.

In an embodiment, the configuration parameters are written to a configuration file, as described in greater detail below. The configuration parameters specify attributes or properties for the desired key effects for a media production. Hence, one configuration parameter is the background media source. By specifying the background media source, the director identifies the media production that will be keyed according to the present invention. For example if the media production is a live or as-live signal, the director would select an input port (e.g., “input 1”) to the keying system and a video source (e.g., “camera 1”). Similarly if the media production is repurposed or an on-demand selection of a recording, the director would select an input port (e.g., “input 2”), a source (e.g., “virtual recorder 1”), and a filename.

A second configuration parameter is a fill source. The fill source specifies a device and/or file for media or multimedia content that will be keyed on the background media production. The key fill comprises data, graphics, text, title, captioning, matte color, photographs, still stores, video, animation, or any other type of media or multimedia.

By specifying the key fill, the director indicates the source and content (e.g., template, filename, etc.) of the fill. Therefore, the source can be a graphic device, character generator, video server, file server, or the like.

Another configuration parameter is a key source. The key source is associated with the fill source and specifies the shape and position of the key fill on the background media. For example, a key can be located in the lower-third region of the background, in the upper-third as commonly used for over-the-shoulder keying, or the like. The key source, in essence, is used to cut a hole in the background media. The key source can come from the same device that provides the key source or another device, which feeds the key source to the keyer switcher to cut the key hole.

At step 109, the configuration parameters are accessed, and at step 112, an unoccupied keyer is selected to receive the configuration parameters. The current state of all keyers are monitored to determine if the keyers are currently in use. If a keyer is not being used, this unoccupied keyer is identified and selected.

At step 115, the configuration parameters are executed to route the specified background media, fill, and key sources to the selected keyer. The configuration parameters also instruct the selected keyer to automatically produce a composite shot or image displaying the desired key effects, namely the predefined background media, key and fill.

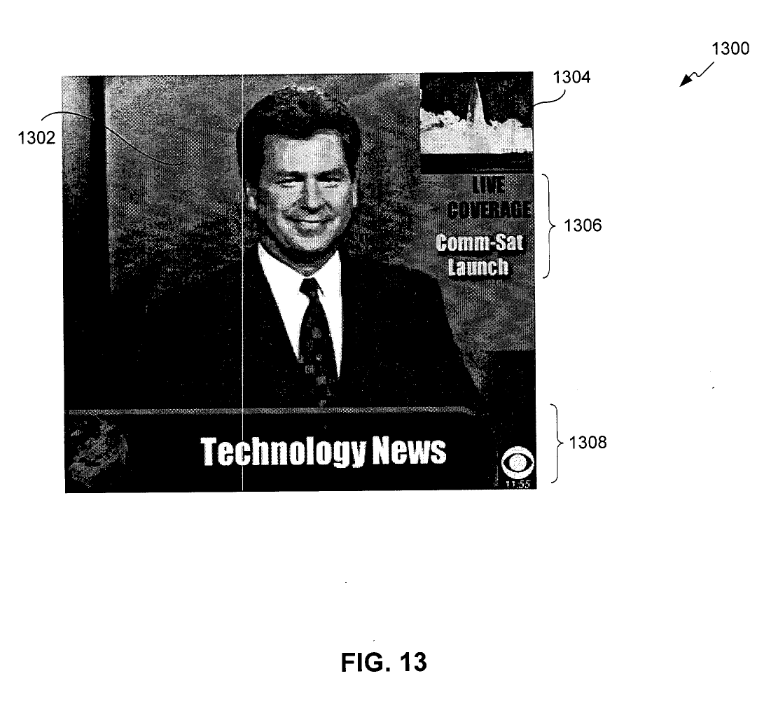

FIG. 13 illustrates an example of a composite shot 1300 according to an embodiment of the present invention. As shown, a background video 1302 can include a video of a news anchor coming from a camera in a television studio. The key signal can come from a graphic device and is fed into a production switcher to cut a hole in background video 1302. A fill video 1304 is used to fill the hole to complete composite shot 1300. Fill 1304 can be a second video that is fed into the production switcher from the graphic device or another source. In this example, fill video 1304 is displayed in an over-the-shoulder (OTS) box. The OTS box includes the fill video 1304 along with an additional graphic, picture, or text (collectively shown as 1306) to support the topic being discussed by the news anchor. The key signal can also instruct the production switcher to receive graphic titles 1308 from a character generator, and key the titles 1308 at the lower third portion of the on-camera shot of the news anchor. The keyed titles 1308 can be translucent (such as, the CBS™ icon) or opaque (i.e., “Technology News”) with respect to background video 1302.

The example depicted in FIG. 13 has been described with reference to a linear keyer in a live production environment. However, it should be understood that the present invention also can be used with linear keyers, luminance keyers, chroma keyers, or a combination thereof.

Referring back to FIG. 1 at step 118, the composite shot is fed over a preview channel to a display or storage medium. At step 121, the director reviews the composite shot on a preview display for accuracy. If the composite shot requires any modifications, the director can reset the configuration parameters at step 103.

On the other hand if the composite shot is approved, the control flow passes to step 124. At step 124, the director steps or transitions the composite shot from preview to program output. The program output takes the composite media production to air and/or to a storage medium. Afterwards, the control flow ends as indicated at step 195.

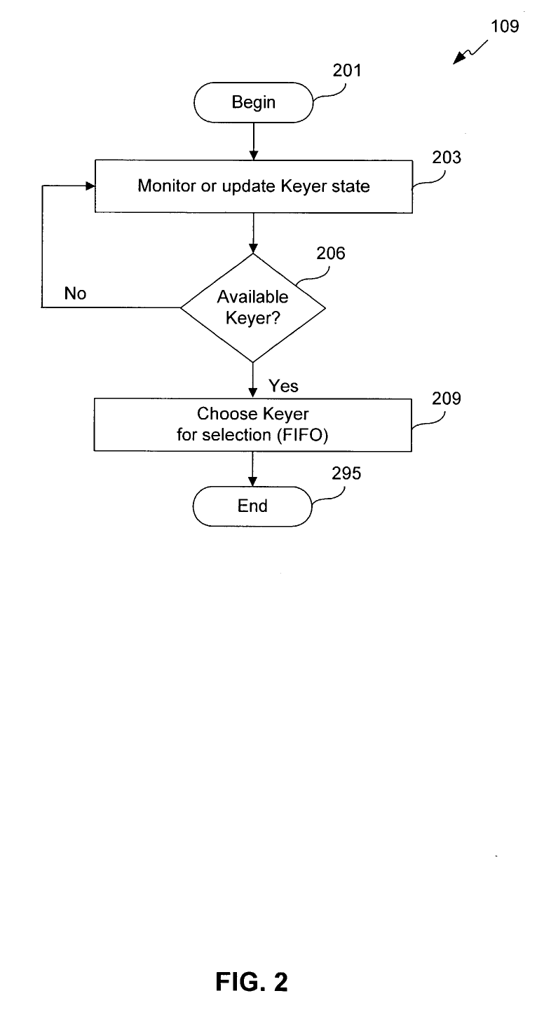

As discussed above, the present invention allows the operating states of a plurality of keyers to be monitored and selected for compositing keyer layers. Referring to FIG. 2, flowchart 200 represents the general operational flow of an embodiment of keyer selection step 109. More specifically, flowchart 200 shows an example of a control flow for identifying and selecting an unoccupied keyer according to the present invention.

The control flow of flowchart 200 begins at step 201 and passes immediately to step 203. At step 203, all keyers are monitored to determine or update their operating states. In an embodiment, each keyer is monitored to determine if the keyer is compositing a media production over a program channel, compositing a media production over a preview channel, or not being used at all. In another embodiment, each keyer is monitored to determine whether or not the keyer is being used without regard to whether the keyer is in a preview or program state. If the keyer is not being used, it is deemed as being available and is denoted as being in an “unoccupied” state.

At step 206, the keyer states are evaluated. If no keyers are in an unoccupied state, the control flow passes back to step 203 and the keyer states are monitored until a keyer becomes available. In an embodiment, a message is sent to the director and the director is granted an option to manually change the state of an occupied keyer (i.e., program or preview state).

If one or more unoccupied keyers are found, the control flow passes to step 209. All unoccupied keyers are queued and selected on a first-in-first-out (FIFO) basis. Hence as future keyers become available, the keyers are placed at the bottom of the queue. As needed, keyers are selected from the top of the queue to perform the keying operations. Although the present invention implements a FIFO routine to select keyers from a queue, other selection techniques and methodologies can be used as long as an available keyer can be automatically chosen with little or no user interaction. After an unoccupied keyer is selected, the control flow ends as indicated at step 295.

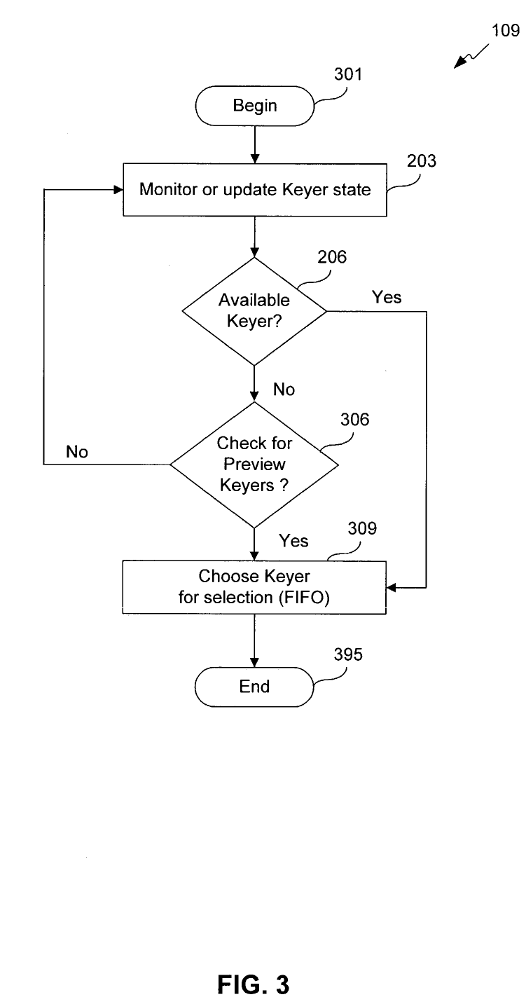

In FIG. 2, only unoccupied keyers are selected. However as discussed, the director can be granted an option to select an occupied keyer if no unoccupied keyers are available. In an embodiment, a preview keyer can be identified and selected automatically. The capability of selecting a preview keyer is described with reference to FIG. 3, where flowchart 300 represents the general operational flow of another embodiment of keyer selection step 109. More specifically, flowchart 300 shows another example of a control flow for identifying and selecting an unoccupied keyer according to the present invention.

The control flow of flowchart 300 begins at step 301 and passes immediately to step 203. At step 203, the operating states are monitored or updated to determine whether the keyers are in a program, preview, or unoccupied state as previously discussed. At step 206, the keyer states are evaluated. If an unoccupied keyer is found, the control flow passes to step 309. In no unoccupied keyer is found, the control flow passes to step 306.

At step 306, the keyer states are evaluated to determine if any keyer is currently compositing video for a preview channel. If no keyer is in a preview state, the control flow passes back to step 203. If at least one preview keyer is found, the control flow passes to step 309.

At step 309, a keyer identified from step 206 or step 306 is selected. The keyers are queued according to their operating state (e.g., unoccupied, preview, etc.). The queues are emptied on a FIFO basis, or the like. Once a selection has been made, the control flow ends as indicated at step 395.

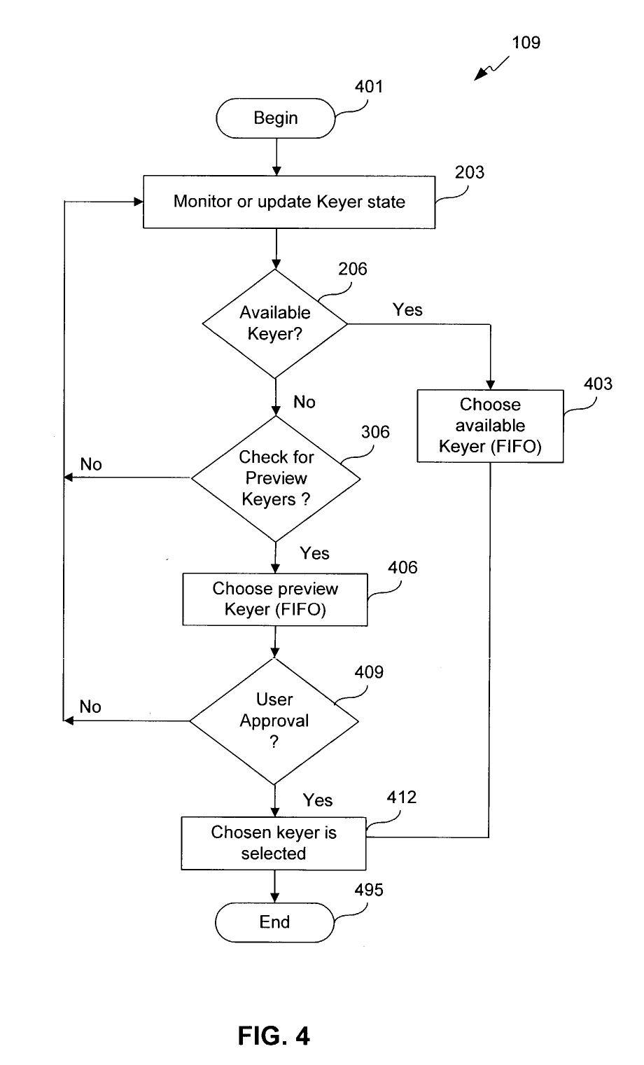

In FIG. 3, a preview keyer is automatically selected if no unoccupied keyers are found. However, in another embodiment of the present invention, the director can accept or reject the selected preview keyer. This is described with reference to FIG. 4, where flowchart 400 represents the general operational flow of another embodiment of keyer selection step 109. More specifically, flowchart 400 shows another example of a control flow for identifying and selecting an unoccupied keyer according to the present invention.

The control flow of flowchart 400 begins at step 401 and passes immediately to step 203. At step 203, the operating states are monitored or updated as previously discussed. At step 206, the keyer states are evaluated. If an unoccupied keyer is found, the control flow passes to step 403. At step 403, an unoccupied keyer is chosen from an unoccupied queue using FIFO or the like, as discussed above.

If no unoccupied keyer is found at step 206, the control flow passes to step 306. At step 306, the keyer states are evaluated to determine if any preview keyers are found. If no keyer is in a preview state, the control flow passes back to step 203. If at least one preview keyer is found, the control flow passes to step 406.

At step 406, a keyer is chosen from a preview queue using FIFO or the like. At step 409, the director is sent a message and given the option of approving or rejecting the chosen keyer. If approval is denied, the control flow passes back to step 203. Otherwise, the control flow passes to step 412.

At step 412, the chosen keyer from step 409 or step 403 is identified and implemented as the selected keyer. Once a selection has been made, the control flow ends as indicated at step 495.

Flowchart 400 shows that the director approves or rejects the keyer chosen at step 406 (i.e., a preview keyer). This gives the director control over whether a currently keyed production should be interrupted or cancelled. This can be an effective mechanism for incorporating a late-breaking news segment, or some other type of unforeseeable event, into a live production. Examples of a system and method for inserting late-breaking events into an automated production is described in the pending U.S. application entitled “System and Method for Real Time Video Production and Multicasting” (U.S. application Ser. No. 09/634,735), which is incorporated herein by reference as though set forth in its entirety.

However in another embodiment, the director may approve or reject the keyer chosen at either step 406 (i.e., a preview keyer) or step 403 (i.e., an unoccupied keyer). Therefore, the rationale for approving a chosen keyer is not limited to whether to interrupt a currently keyed production.

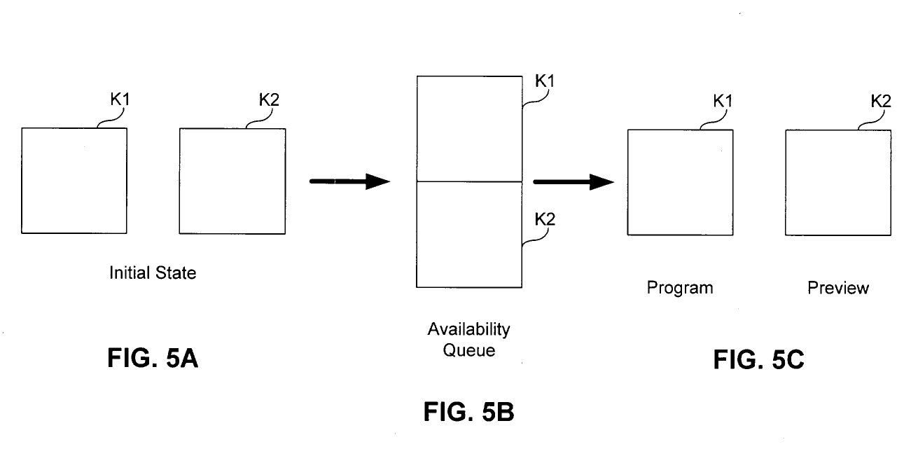

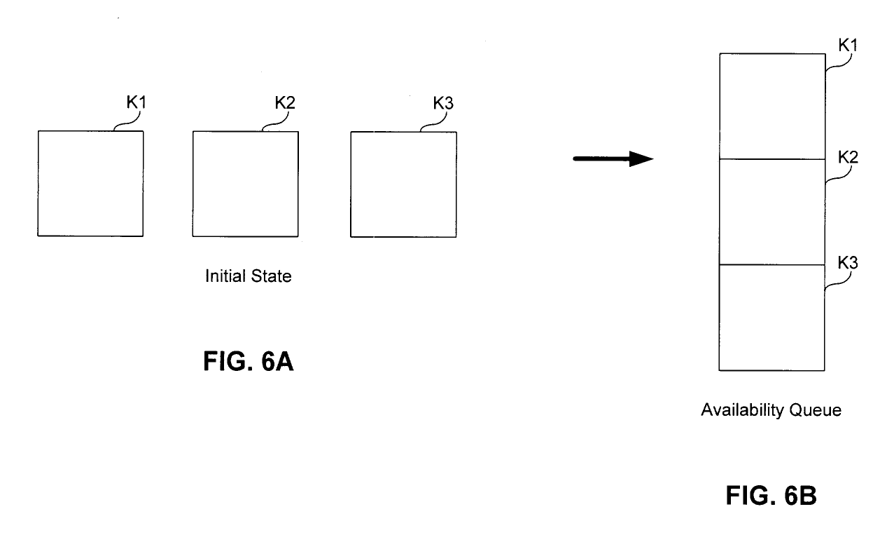

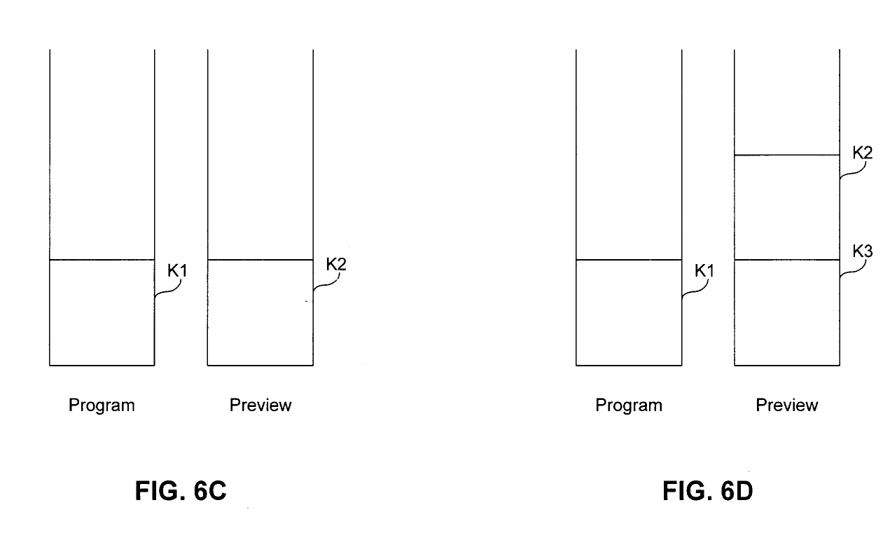

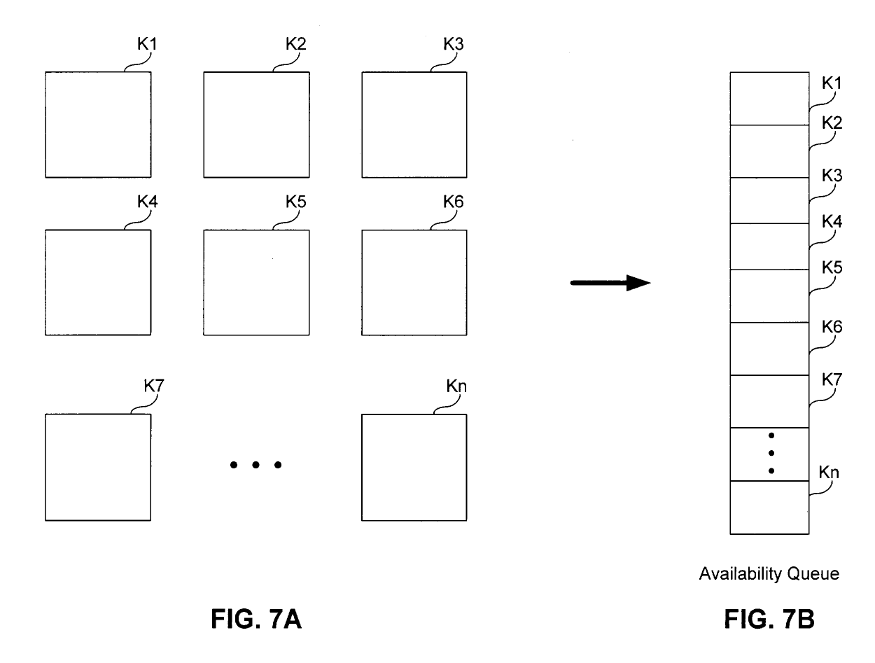

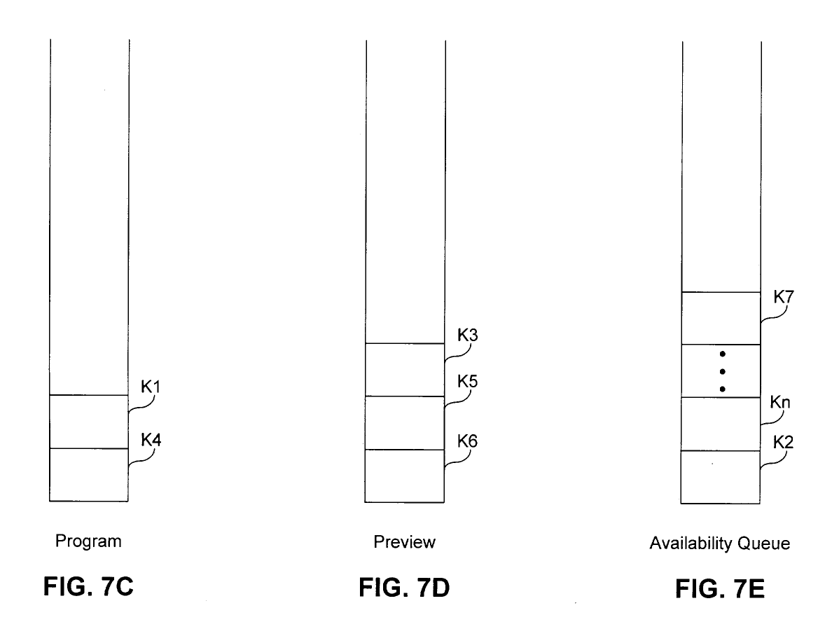

As discussed, in an embodiment, the keyers of the present invention are queued and emptied on a FIFO basis. This routine is explained with reference to FIGS. 5-7, which illustrate the queuing and selecting process for different quantities of keyers. Specifically, FIGS. 5a-5c provide an example using two keyers. FIGS. 6a-6d provide an example using three keyers. Finally, FIGS. 7a-7e provide an example using a plurality of keyers. Hence, the present invention is not restricted to the quantity of keyers.

FIGS. 5a-5c illustrate various keyer states for two keyers (i.e., K1 and K2) that are queued and selected for a program and preview channel, according to the present invention. FIG. 5a. show keyer K1 and keyer K2 in an initial state. At this point in time, both keyers are unoccupied. As such, keyer K1 and keyer K2 are placed in an availability queue as shown in FIG. 5b. In FIG. 5c, keyer K1 is selected from the availability queue, and is being used to key program output. Keyer K2 is selected to key a preview channel.

FIGS. 6a-6d illustrate another example of keyers being setup in a queue and selected for compositing a media production. FIG. 6a shows three keyers (i.e., K1, K2, and K3) in an initial unoccupied state. FIG. 6b shows keyer K1, keyer K2, and keyer K3 after they have been placed in an availability queue. In FIG. 6c, the availability queue has been emptied, using FIFO, to place keyer K1 in a program state and keyer K2 in a preview state. In FIG. 6d, the director has selected keyer K3 to preview a second keyed shot. The keyer state of keyer K3 is monitored by placing it at the bottom of the preview queue. As such, if the preview queue is searched to select a keyer, as discussed with reference to FIGS. 3 and 4, keyer K2 would be the first keyer selected from the top of the preview queue.

FIGS. 7a-7e illustrates another embodiment of the present invention that supports a plurality of keyers K1-Kn. FIG. 7a shows keyers K1-Kn in their initial unoccupied states. FIG. 7b shows the unoccupied keyers K1-Kn in an availability queue. FIG. 7c shows that first keyers K1 and then keyer K4 have been selected and transitioned to a program state. FIG. 7d shows that first keyer K3, then keyer K5, and finally keyer K6 are operating in a preview state. In FIG. 7e, the current status of the availability queue includes keyers K7-Kn and K2. Keyer K2 is at the bottom of the availability queue because it was previously selected for preview or program, but currently, is no longer in use. Hence, keyer K2 goes to the bottom because the availability queue is emptied according to a FIFO routine as previously discussed.

As described above, the present invention allows one or more keyers to be programmed ahead of time without having to consider the source of a current media production or whether a keyer is being used. The present invention also allows automatic preparation of the next composited media production that will be taken to air. When it is time for the next shot and if the next shot requires a keyed image, the control flow of FIG. 1 is repeated for the next shot. If a keyed image is not required, the automated keyers are deactivated, and the background media production continues to be processed through the keyer system but without any video manipulation.

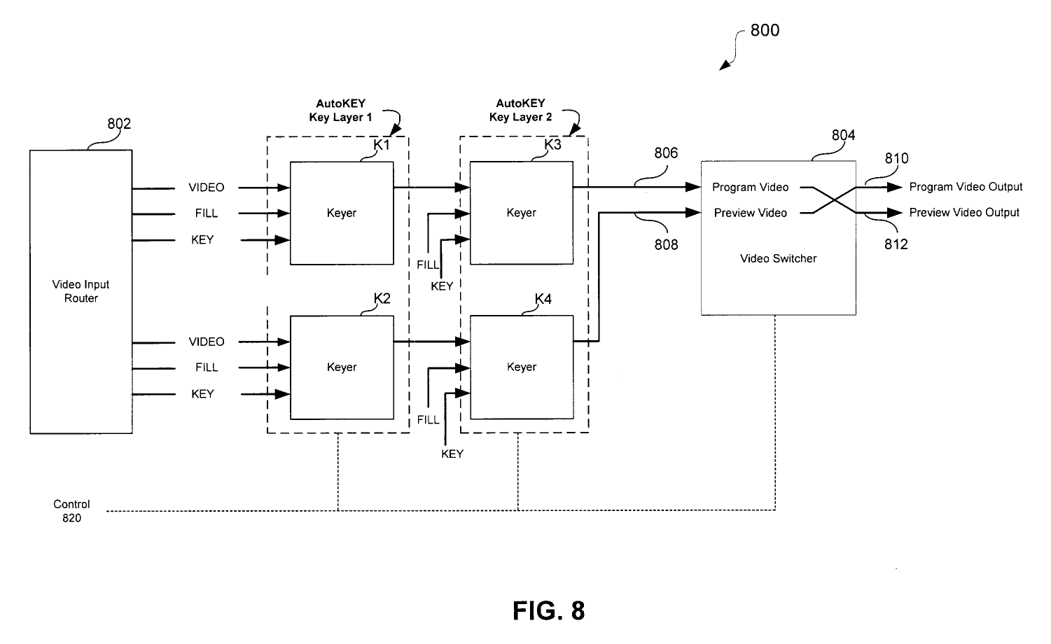

FIG. 8 illustrates a keyer system 800 according to an embodiment of the present invention. Keyer system 800 includes an input router 802, a plurality of keyers K1-K4, and a video switcher 804. Input router 802 receives the background, fill, and key sources as discussed above. Input router 802 routes the sources an appropriate keyer K1-K4 that has been selected, as discussed above. Keyers K1-K4 can be internal or external to video switcher 804. Keyers K1-K4 can be a luminance keyer, chroma keyer, linear keyer, or a combination thereof.

As can be seen, keyer system 800 enables a media production to be configured with two keyer layers. Keyers K1 and K2 provide a first keyer layer. A second keyer layer is provided by keyers K3 and K4.

Keyers K1 and K3 provide a composite shot to a program input port 806 of video switcher 804, and keyers K2 and K4 provide a composite shot to a preview input port 808 of video switcher 804. According to an embodiment of the present invention, composited shots are always “automatically” sent to a preview channel. Once the background, key, and fill sources are selected and composited on preview, the director “steps” or “transitions” the shot from a preview output 812 to a program output 810. Therefore, keyer system 800 is setup on “preview” to see a “composite” view prior to taking the shot to air. The preview process provides assurance that the composite shot meets the director's approval prior to “transitioning” to air on the “program” channel.

Although keyer system 800 shows two keyer layers being composited on a background, system 800 also allows a single key on both program 806 and preview 808 inputs to switcher 804. Since the fixed architecture of FIG. 8 shows two keyers serially positioned, a keyed production having a single key would pass through the second keyer (i.e., K3 or K4) without being keyed. Additionally as previously discussed, if a keyed image is not required, the background media production is routed, without any fill or key sources, through both keyers (i.e., K1 and K3, or K2 and K4) to switcher 804.

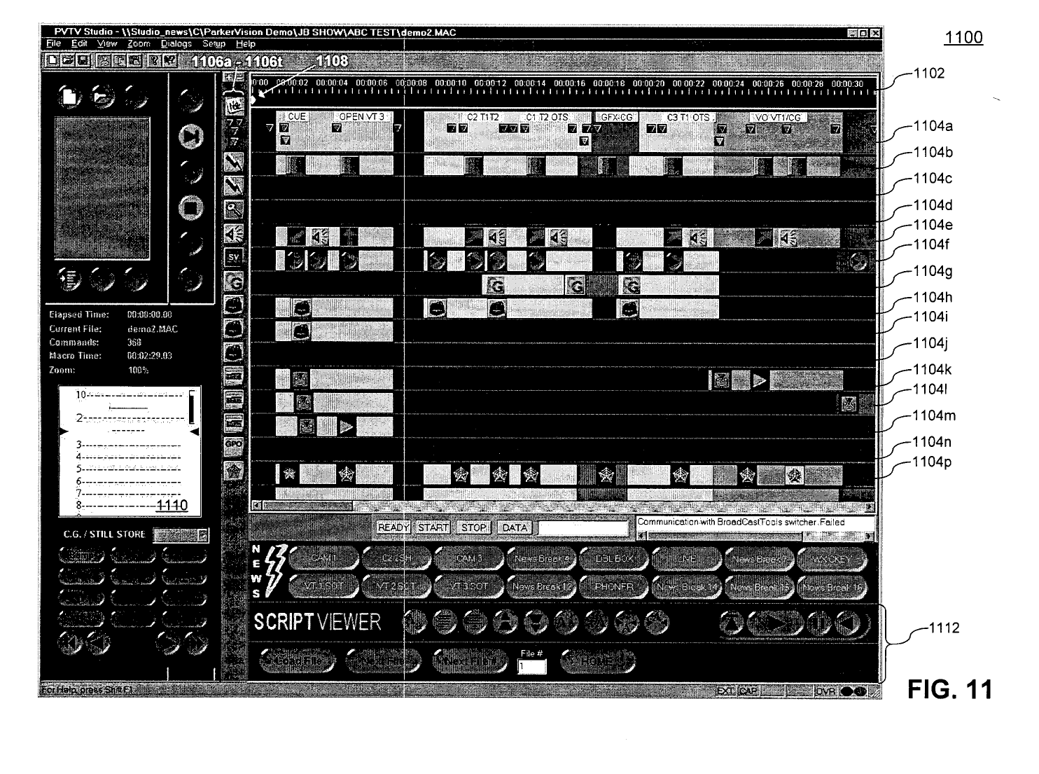

Control signals 820 are transmitted from a media production processing device, which is described below with reference to FIG. 11. Control signals 820 provide instructions to various components of system 800, such as instructions to switch between program output 810 and preview output 812. Control signals 820 also enable a keyer K1-K4 to be manipulated and switched remotely via communications from a user interface.

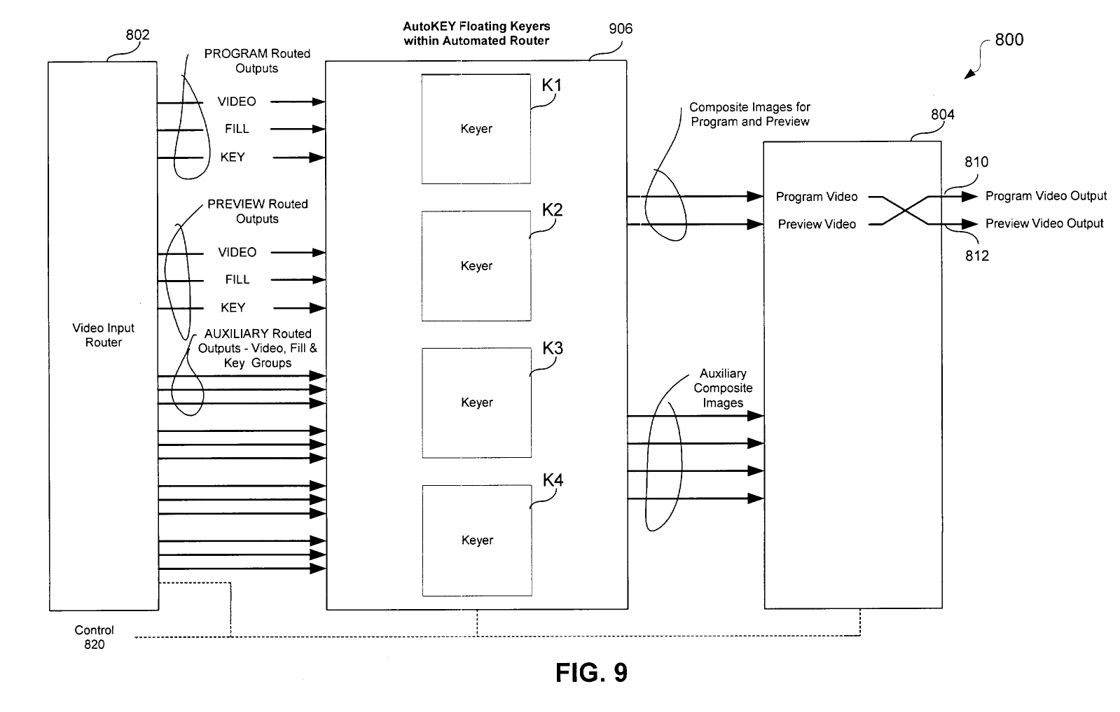

FIG. 9 illustrates another embodiment of keyer system 800. As shown, keyers K1-K4 reside within a router 906 that allows keyers K1-K4 to “float.” This means that keyers K1-K4 can be grouped in serial and parallel variable arrangements and assigned to the appropriate signal flow path to program 810 and preview 812 channels automatically. In an embodiment, keyer system 800 is programmed through software to key two layers back-to-back between preview and program over and over again. In another embodiment, the director programs keyer system 800 to go from an “on-camera” shot with no keyer layers to one with four keyer layers.

As discussed above with reference to FIG. 1, the operating states of floating keyers K1-K4 can be monitored and, thus programmed, without the director having to track which keyer is being used for what effect to make sure they do not impact the composite picture on the program channel. To accomplish this, the logic in the software always knows which keyers K1-K4 are on program and which ones are available for the user. In addition, keyers K1-K4 always route the signals to “preview” during the automation process.

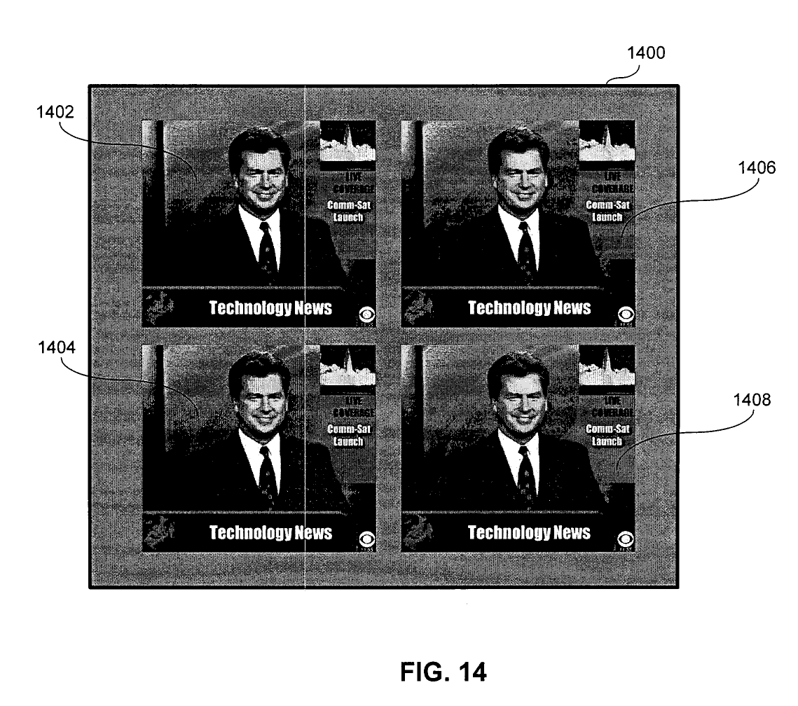

In an embodiment, input router 802 allows auxiliary pairs of background, fill, and key signals to go into the floating keyer router 906. The auxiliary inputs allow the director to composite images with keys for insertion in dual, tri or quad box applications. FIG. 14 shows an example of a quad box display 1400 for a quad box application according to an embodiment of the present invention. Quad box display 1400 provides sufficient auxiliary sets 1402-1408 of background, fill, and key signals (i.e., four sets) for up to a four-channel digital video effect (DVE) boards. The present invention can support more or less channels of DVE and is not to be considered a limitation. In addition, the architecture can support more or less floating keyers K1-K4. As shown in FIGS. 7a-7e, the architecture of the present invention can be modified to support a plurality of keyers K1-Kn.

The architecture illustrated in FIG. 9 provides the flexibility for multiple variations of production compositing. From simple keyer layers on an “on-camera” shot, to multiple keyer layers back-to-back, and all the way to being able to composite keyer layers within inserts of a DVE double, tri, quad, or greater sized box application.

The present invention can be implemented in a manual media production environment as well as an automated media production environment. The pending U.S. application entitled “Method, System and Computer Program Product for Producing and Distributing Enhanced Media Downstreams” (U.S. application Ser. No. 09/836,239) describes representative embodiments of manual and automated multimedia production systems that are implementable with the present invention, and is incorporated herein by reference in its entirety. As described in the aforesaid U.S. application, an automated multimedia production environment includes a centralized media production processing device that automatically or semi-automatically commands and controls the operation of a variety of media production devices in analog and/or digital video environments. The term “media production device” includes video switcher (such as, switcher 810), digital video effects device (DVE), audio mixer, teleprompting system, video cameras and robotics (for pan, tilt, zoom, focus, and iris control), record/playback device (RPD), character generator, still store, studio lighting devices, news automation devices, master control/media management automation systems, commercial insertion devices, compression/decompression devices (codec), virtual sets, or the like. The term “RPD” includes VTRs, video recorders/servers, virtual recorder (VR), digital audio tape (DAT) recorder, or any mechanism that stores, records, generates or plays back via magnetic, optical, electronic, or any other storage media. In an embodiment, the media production processing device receives and routes live feeds (such as, field news reports, news services, sporting events, or the like) from any type of communications source, including satellite, terrestrial (e.g., fiber optic, copper, UTP, STP, coaxial, hybrid fiber-coaxial (HFC), or the like), radio, microwave, free-space optics, or any other form or method of transmission, in lieu of, or in addition to, producing a live show within a studio.

In addition to controlling media production devices, an automated media production processing device is configurable to convert an electronic show rundown into computer readable broadcast instructions, which are executed to send control commands to the media production devices. An exemplary embodiment of an electronic rundown is described in greater detail below with reference to FIG. 11. An electronic show rundown is often prepared by the show director, a web master, web cast director, or the like. The director prepares the rundown to specify element-by-element instructions for producing a live or non-live show.

An electronic rundown can be a text-based or an object-oriented listing of production commands. When activated, electronic rundown is converted into computer readable broadcast instructions to automate the execution of a show without the need of an expensive production crew to control the media production devices. In an embodiment, the broadcast instructions are created from the Transition Macro™ multimedia production control program developed by ParkerVision, Inc. (Jacksonville, Fla.) that can be executed to control an automated multimedia production system. The Transition Macro™ program is described in the pending U.S. application entitled “System and Method for Real Time Video Production and Multicasting” (U.S. application Ser. No. 09/634,735), which is incorporated herein by reference as though set forth in its entirety. As described in the aforesaid U.S. application, the Transition Macro™ program is an event-driven application that allows serial and parallel processing of media production commands to automate the control of a multimedia production environment. Each media production command is associated with a timer value and at least one media production device.

FIG. 11 illustrates an embodiment of an object-oriented, electronic show rundown created by an event-driven application on a graphical user interface (GUI) 1100. The electronic rundown includes a horizontal timeline 1102 and one or more horizontal control lines 1104a-1104p. Automation control icons 1106a-1106t are positioned onto control lines 1104a-1104p at various locations relative to timeline 1102, and configured to be associated with one or more media production commands and at least one media production device.

A timer (not shown) is integrated into timeline 1102, and operable to activate a specific automation control icon 1106a-1106t as a timer indicator 1108 travels across timeline 1102 to reach a location linked to the specific automation control icon 1106a-1106t. As a result, the media production processing device would execute the media production commands to operate the associated media production device.

In regards to automation control icons 1106a-1106t, label icon 1106a permits a director to name one or more elements, segments, or portions of the electronic rundown. In embodiment, the director would drag and drop a label icon 1106a onto control line 1104a, and double click on the positioned label icon 1106a to open up a dialogue box to enter a text description. The text would be displayed on the positioned label icon 1106a. Referring to FIG. 11, exemplary label icons 1106a have been generated to designate “CUE,” “OPEN VT 3,” “C2 T1 T2,” etc.

Control line 1104a is also operable to receive a step mark icon 1106b, a general purpose input/output (GPI/O) mark icon 1106c, a user mark icon 1106d, and an encode mark 1106e. Step mark icon 1106b and GPI/O mark icon 1106c are associated with rundown step commands. The rundown step commands instruct timer indicator 1108 to start or stop running until deactivated or reactivated by the director or another media production device. For example, step mark icon 1106b and GPI/O mark icon 1106c can be placed onto control line 1104a to specify a time when timer indicator 1108 would automatically stop running. In other words, timer indicator 1108 would stop moving across timeline 1102 without the director having to manually stop the process, or without another device (e.g., a teleprompting system (not shown)) having to transmit a timer stop command. If a step mark icon 1106b is activated to stop timer indicator 1108, timer indicator 1108 can be restarted either manually by the director or automatically by another external device transmitting a step command. If a GPI/O mark icon 1106c is used to stop timer indicator 1108, timer indicator 1108 can be restarted by a GPI or GPO device transmitting a GPI/O signal.

In an embodiment, step mark icon 1106b and GPI/O mark icon 1106c are used to place a logically break between two elements on the electronic rundown. In other words, step mark icon 1106b and GPI/O mark icon 1106c are placed onto control line 1140a to designate segments within a media production. One or more configuration files can also be associated with a step mark icon 1106b and GPI/O mark icon 1106c to link metadata with the designated segment.

Encode mark 1106e can also be placed on control line 1104a. In an embodiment, encode mark 1106e is generated by the Web Mark™ software application developed by ParkerVision, Inc. Encode mark 1106e identifies a distinct segment within the media production produced by the electronic rundown of GUI 1100. As timer indicator 1108 advances beyond encode mark 1106e, an encoding system is instructed to index the beginning of a new segment. The encoding system automatically clips the media production into separate files based on the placement of encode mark 1106e. This facilitates the indexing, cataloging and future recall of segments identified by the encode mark 1106e. Encode mark 1106e allows the director to designate a name for the segment, and specify a segment type classification. Segment type classification includes a major and minor classification. For example, a major classification or topic can be sports, weather, headline news, traffic, health watch, elections, and the like. An exemplary minor classification or category can be local sports, college basketball, NFL football, high school baseball, local weather, national weather, local politics, local community issues, local crime, editorials, national news, and the like. Classifications can expand beyond two levels to an unlimited number of levels for additional granularity and resolution for segment type identification and advertisement targeting. In short, the properties associated with each encode mark 1106e provide a set of metadata that can be linked to a specific segment. These properties can be subsequently searched to identify or retrieve the segment from an archive.

Transition icons 1106f-1106g are associated with automation control commands for controlling video switching equipment. Thus, transition icons 1106f-1106g can be positioned onto control lines 1104b-1104c to control one or more devices to implement a variety of transition effects or special effects into a media production. Such transition effects include, but are not limited to, fades, wipes, DVE, downstream keyer (DSK) effects, and the like. DVE includes, but is not limited to, warps, dual-box effects, page turns, slab effects, and sequences. DSK effects include DVE and DSK linear, chroma and luma keyers (such as, K1-K4 and K1-Kn, discussed above).

Keyer control icon 1106h is positioned on control line 1104d, and used to prepare and execute keyer layers either in linear, luma, chroma or a mix thereof for preview or program output. The keyers can be upstream or downstream of the DVE.

Audio icon 1106i can be positioned onto control line 1104e and is associated with commands for controlling audio equipment, such as audio mixers, digital audio tape (DAT), cassette equipment, other audio sources (e.g., CDs and DATs), and the like. Teleprompter icon 1106j can be positioned onto control line 1104f and is associated with commands for controlling a teleprompting system to integrate a script into the timeline. Character generator (CG) icon 1106k can be positioned onto control line 1104g and is associated with commands for controlling a CG or still store to integrate a CG page into the timeline. Camera icons 11061-1106n can be positioned onto control lines 1104h-1104j and are associated with commands for controlling the movement and settings of one or more cameras. VTR icons 1106p-1106r can be positioned onto control lines 1104k-1104m and are associated with commands for controlling VTR settings and movement. GPO icon 1106s can be positioned onto control line 1104n and is associated with commands for controlling GPI or GPO devices.

Encode object icons 1106t are placed on control line 1104p to produce encode objects, and is associated with encoding commands. In an embodiment, encode object icons 1106t are produced by the Web Objects™ software application developed by ParkerVision, Inc. When activated, an encode object icon 1106t initializes the encoding system and starts the encoding process. A second encode object icon 1106t can also be positioned to terminate the encoding process. Encode object icon 1106t also enables the director to link context-sensitive or other media (including an advertisement, other video, web site, etc.) with the media production. In comparison with encode mark 1106e, encode object icon 1106t instructs the encoding system to start and stop the encoding process to identify a distinct show, whereas encode mark 1106e instructs the encoding system to designate a portion of the media stream as a distinct segment. The metadata contained in encode object icon 1106t is used to provide a catalog of available shows, and the metadata in encode mark 1106e is used to provide a catalog of available show segments.

User mark icon 1106d is provided to precisely associate or align one or more automation control icons 1106a-1106c and 1106e-1106t with a particular time value. For example, if a director desires to place teleprompter icon 1106j onto control line 1104f such that the timer value associated with teleprompter icon 1106j is exactly ten seconds, the director would first drag and drop user mark icon 1106d onto control line 1104a at the ten second mark. The director would then drag and drop teleprompter icon 1106j onto the positioned user mark icon 1106d. Teleprompter icon 1106j is then automatically placed on control line 1104f such that the timer value associated with teleprompter icon 1106j is ten seconds. In short, any icon that is drag and dropped onto the user mark 1106d is automatically placed on the appropriate control line and has a timer value of ten seconds. This feature helps to provide multiple icons with the exact same timer value.

After the appropriate automation control icons 1106 have been properly position onto the electronic rundown, the electronic rundown can be stored in a file for later retrieval and modification. Accordingly, a show template or generic electronic rundown can be re-used to produce a variety of different shows. A director could recall the show template by filename, make any required modifications (according to a new electronic rundown), and save the electronic rundown with a new filename.

As described above, one media production device is a teleprompting system (not shown) that includes a processing unit and one or more displays for presenting a teleprompting script (herein referred to as “script”) to the talent. In an embodiment, the teleprompting system is the SCRIPT Viewer™, available from ParkerVision, Inc. As described in the pending U.S. application entitled “Method, System and Computer Program Product for Producing and Distributing Enhanced Media Downstreams” (U.S. application Ser. No. 09/836,239), a teleprompting system can be used to create, edit, and run scripts of any length, at multiple speeds, in a variety of colors and fonts. In an embodiment of the present invention, the teleprompting system is operable to permit a director to use a text editor to insert media production commands into a script (herein referred to as “script commands”). The text editor can be a personal computer or like workstation, or the text editor can be an integrated component of electronic rundown GUI 1100. Referring to FIG. 11, text window 1110 permits a script to be viewed, including script commands. Script controls 1112 are a set of graphical controls that enable a director to operate the teleprompting system and view changes in speed, font size, script direction and other parameters of the script in text window 1110.

The script commands that can be inserted by the teleprompting system include a cue command, a delay command, a pause command, a rundown step command, and an enhanced media command. As discussed below, enhanced media commands permit the synchronization of auxiliary information to be linked for display or referenced with a script and video. This allows the display device to display streaming video, HTML or other format graphics, or related topic or extended-play URLs and data. The present invention is not limited to the aforementioned script commands. As would be apparent to one skilled in the relevant art(s), commands other than those just listed can be inserted into a script.

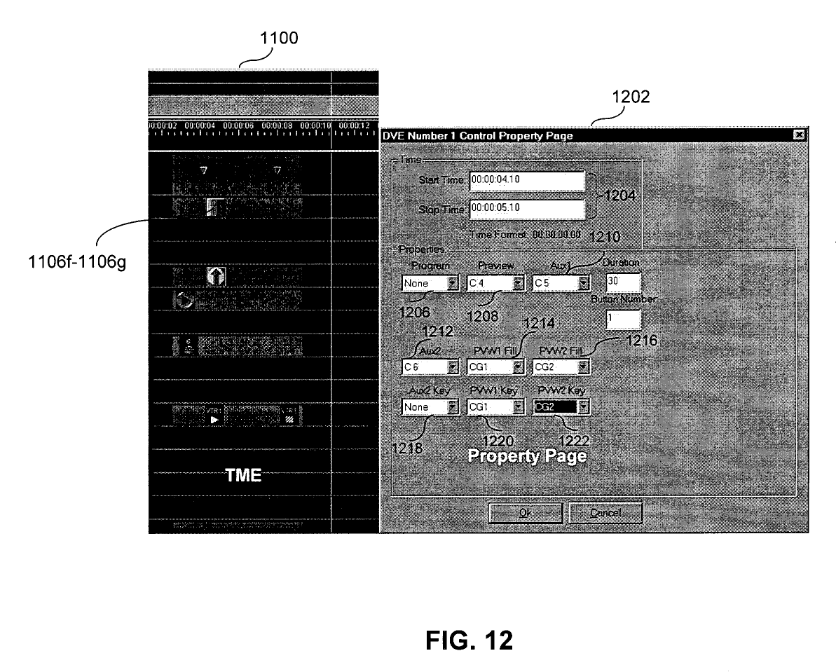

Thus, GUI 1100 enables the director to automate the control of the media production devices. GUI 1100 also enables the director to establish the configuration parameters, described above, for implementing the keying effects according to the present invention. As discussed, transition icons 1106f-1106g can be positioned onto control lines 1104b-1104c to setup DSK effects as well as other transition effects. If the director operates an input device to double click on a positioned transition icon 1106f-1106g, a dialogue box is opened to allow the director to specify a background, fill, and key source for the configuration parameters. This can be explained with reference to FIG. 12.

FIG. 12 shows a portion of the electronic rundown of GUI 1100. As shown, the activation of a transition icon 1106f-1106g generates a dialogue box 1202. Dialogue box 1202 allows the directors to set the transition properties, including the configuration parameters for key effects. Dialogue box 1202 includes time field 1204, which denotes the start and stop time value for implementing the key effects. The time value in time field 1204 corresponds to the timer values on timeline 1102.

Dialogue box 1202 also includes a program background field 1206, a preview background field 1208, and an auxiliary background field 1210. Program background field 1205, preview background field 1208, and auxiliary background field 1210 identify the background source of the media production to be keyed. Referring back to FIG. 9, program background field 1206, preview background field 1208, and auxiliary background field 1210 identify the input port(s) that input router 802 uses to receive the program routed video outputs, preview routed video outputs, and auxiliary routed video outputs, respectfully, for router 906.

Referring back to FIG. 12, a program fill field 1214 identifies a program fill source that is keyed on the program background media. A preview fill field 1216 identifies a preview fill source that is keyed on the preview background media. Additionally, an auxiliary fill field 1212 identifies an auxiliary fill source that is keyed on the auxiliary background media. Referring back to FIG. 9, program fill field 1214, preview fill field 1216, and auxiliary fill field 1210 identify the input port(s) that input router 802 uses to receive the program routed fill outputs, preview routed fill outputs, and auxiliary routed fill outputs, respectfully, for router 906.

Also shown in FIG. 12, a program key field 1220 identifies a program key source that is associated with program fill field 1214. In addition, a preview key field 1222 identifies a preview key source that is associated with preview fill field 1216. Further, an auxiliary key field 1218 identifies an auxiliary key source that is associated with auxiliary fill field 1212. Referring back to FIG. 9, program key field 1220, preview key field 1222, and auxiliary key field 1218 identify the input port(s) that input router 802 uses to receive the program routed key outputs, preview routed key outputs, and auxiliary routed key outputs, respectfully, for router 906.

Hence when activated, transition icons 1106f-1106g transmit commands that process the predefined fill and key attributes to composite the associated graphic layers within the specified media stream. More specifically, the broadcast instructions corresponding to a positioned transition icon 1106f-1106g are executed as timer 1108 reaches the timer value on timeline 1102 that matches the time value (i.e., time field 1204) specified for the positioned transition icon 1106f-1106g. The broadcast instructions are programmed to select the correct keyer (e.g., K1-K4). In an embodiment, the broadcast instructions call or implement routine that determines which keyer is currently available, as discussed above with reference to FIGS. 1-4. After a keyer is selected, the properties from transition icons 1106f-1106g are assigned to the keyer. The keyed output is placed on a preview bus. This allows the director to review a keyer layer prior to broadcasting the show. The automation supported by the broadcast instructions also allow the director to concentrate on the quality aspect of the show instead of trying to determine which keyer is currently available and where it is routed.

Although GUI 1100 is described with reference to an automated production environment, it should be understood that a similar user interface could be used for a manual production environment. In a manual environment, control lines 1104b-1104c would execute broadcast instructions to select a keyer and assign the keyer attributes. However, the remaining control lines 1104a and 1104d-1104p would not transmit control commands to automate the control of other media production devices. The media production devices would be manually controlled.

FIGS. 1-9 and 11-14 are conceptual illustrations allowing an easy explanation of the present invention. It should be understood that embodiments of the present invention could be implemented in hardware, firmware, software, or a combination thereof. In such an embodiment, the various components and steps would be implemented in hardware, firmware, and/or software to perform the functions of the present invention. That is, the same piece of hardware, firmware, or module of software could perform one or more of the illustrated blocks (i.e., components or steps).

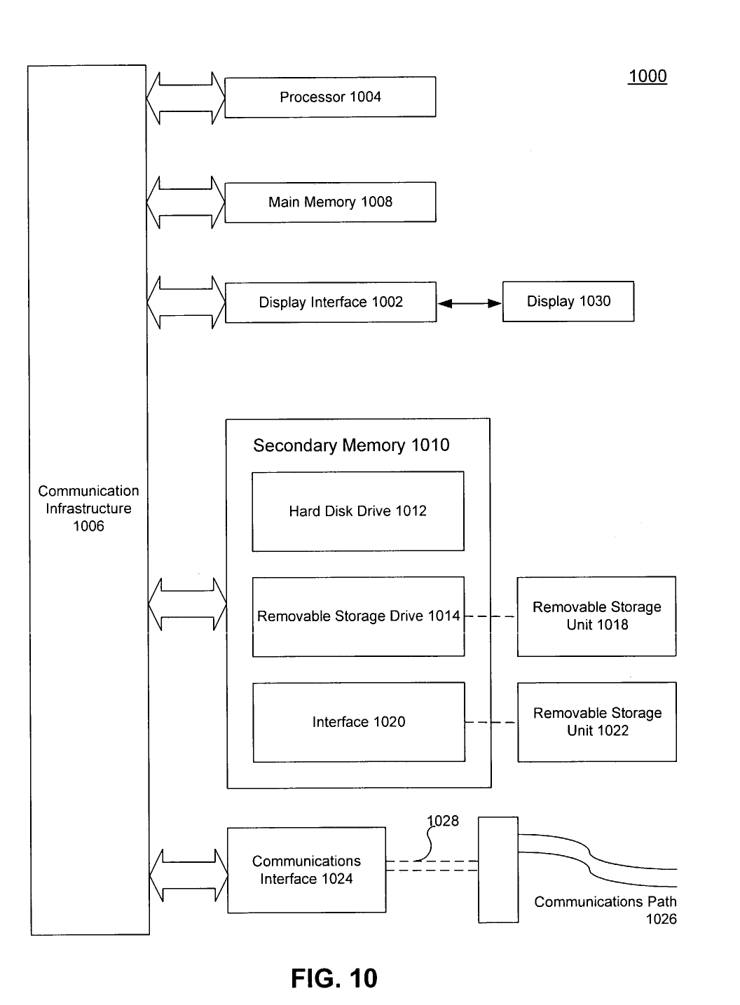

The present invention can be implemented in one or more computer systems capable of carrying out the functionality described herein. Referring to FIG. 10, an example computer system 1000 useful in implementing the present invention is shown. Various embodiments of the invention are described in terms of this example computer system 1000. After reading this description, it will become apparent to one skilled in the relevant art(s) how to implement the invention using other computer systems and/or computer architectures.

The computer system 1000 includes one or more processors, such as processor 1004. The processor 1004 is connected to a communication infrastructure 1006 (e.g., a communications bus, crossover bar, or network). Various software embodiments are described in terms of this exemplary computer system. After reading this description, it will become apparent to one skilled in the relevant art(s) how to implement the invention using other computer systems and/or computer architectures.

Computer system 1000 can include a display interface 1002 that forwards graphics, text, and other data from the communication infrastructure 1006 (or from a frame buffer not shown) for display on the display unit 1030.

Computer system 1000 also includes a main memory 1008, preferably random access memory (RAM), and can also include a secondary memory 1010. The secondary memory 1010 can include, for example, a hard disk drive 1012 and/or a removable storage drive 1014, representing a floppy disk drive, a magnetic tape drive, an optical disk drive, etc. The removable storage drive 1014 reads from and/or writes to a removable storage unit 1018 in a well-known manner. Removable storage unit 1018, represents a floppy disk, magnetic tape, optical disk, etc. which is read by and written to removable storage drive 1014. As will be appreciated, the removable storage unit 1018 includes a computer usable storage medium having stored therein computer software (e.g., programs or other instructions) and/or data.

In alternative embodiments, secondary memory 1010 can include other similar means for allowing computer software and/or data to be loaded into computer system 1000. Such means can include, for example, a removable storage unit 1022 and an interface 1020. Examples of such can include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

Computer system 1000 can also include a communications interface 1024. Communications interface 1024 allows software and data to be transferred between computer system 1000 and external devices. Examples of communications interface 1024 can include a modem, a network interface (such as an Ethernet card), a communications port, a PCMCIA slot and card, etc. Software and data transferred via communications interface 1024 are in the form of signals 1028 which can be electronic, electromagnetic, optical, or other signals capable of being received by communications interface 1024. These signals 1028 are provided to communications interface 1024 via a communications path (i.e., channel) 1026. Communications path 1026 carries signals 1028 and can be implemented using wire or cable, fiber optics, a phone line, a cellular phone link, an RF link, and other communications channels.

In this document, the terms “computer program medium” and “computer usable medium” are used to generally refer to media such as removable storage unit 1018, removable storage unit 1022, a hard disk installed in hard disk drive 1012, and signals 1028. These computer program products are means for providing software to computer system 1000. The invention is directed to such computer program products.

Computer programs (also called computer control logic or computer readable program code) are stored in main memory 1008 and/or secondary memory 1010. Computer programs can also be received via communications interface 1024. Such computer programs, when executed, enable the computer system 1000 to implement the present invention as discussed herein. In particular, the computer programs, when executed, enable the processor 1004 to implement the processes of the present invention, such as the method(s) implemented using various components of system 800 and GUI 1100 described above, such as various steps of method 100, for example. Accordingly, such computer programs represent controllers of the computer system 1000.

In an embodiment where the invention is implemented using software, the software can be stored in a computer program product and loaded into computer system 1000 using removable storage drive 1014, hard drive 1012, interface 1020, or communications interface 1024. The control logic (software), when executed by the processor 1004, causes the processor 1004 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to one skilled in the relevant art(s).

In yet another embodiment, the invention is implemented using a combination of both hardware and software.

The foregoing description of the specific embodiments will so fully reveal the general nature of the invention that others can, by applying knowledge within the skill of the art (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method of controlling a plurality of automated keyers to produce a composite media production, comprising the steps of:
(1) executing a first production command to determine the availability of the plurality of keyers;
(2) selecting an available keyer in response to step (1); and
(3) transmitting a control command that, when executed, instructs said available keyer to produce the composite media production in response to receiving a media production source and a fill source.

2. The method according to claim 1, wherein step (1) further comprises the step of:
(a) monitoring an operating state of at least one of the plurality of keyers to determine said availability.

3. The method according to claim 1, wherein step (1) further comprises the step of:
(a) detecting at least one of the plurality of keyers as being denoted as an unoccupied keyer.

4. The method according to claim 3, wherein step (2) further comprises the step of:
(a) selecting said unoccupied keyer as said available keyer in response to detecting only one unoccupied keyer.

5. The method according to claim 3, wherein step (a) further comprises the steps of:
(i) detecting a plurality of unoccupied keyers.

6. The method according to claim 5, wherein step (2) further comprises the steps of:
(a) identifying one of said plurality of unoccupied keyers that has a current state of being continuously denoted as an unoccupied keyer a greater period of time than other of said plurality of unoccupied keyers; and
(b) selecting said one of said plurality of unoccupied keyers as said available keyer.

7. A method of controlling a plurality of production devices to produce a show, comprising the steps of:
(1) scheduling a sequence of production events for producing a show, each production event being associated with one or more production commands, each of said one or more production commands being executable to send a control command for controlling a corresponding production device;
(2) sending a first control command to produce a media production segment upon completion of a first production event from said sequence; and
(3) sending a second control command to identify an available keyer upon completion of said first production event to key said media production.

8. The method according to claim 7, further comprising the step of:
(4) sending a third control command to deliver said media production segment to said available keyer.

9. The method according to claim 7, further comprising the step of:
(5) sending a fourth control command to access a fill source to key said media production segment.

10. A method of compositing a media production, comprising the steps of:
(1) accessing the media production having a key signal;
(2) monitoring a plurality of keyers to identify an available keyer;
(3) receiving a key fill associated with said key signal;
(4) detecting a key value with said key fill; and
(5) compositing a keyer layer in the media production, said keyer layer comprising said key fill and said key value.

11. The method according to claim 10, wherein said key fill being at least one of a title, text, graphic, video still store, video, and matte color.

12. The method according to claim 10, wherein said key value being at least one of an image shape, a hue, and a brightness level.

13. A system for controlling a plurality of production devices to produce a show, comprising:
an automation control processor for scheduling a sequence of production events within the show, wherein each production event comprises one or more production commands, wherein each of said one or more production commands is executable to send a control command to control a corresponding production device;
a plurality of keyers, wherein state information pertaining to each of said keyers is delivered to said automation control processor; and
an input router for communicating signals from a media production source, a fill source, or a key source to a selected keyer from said plurality of keyers, wherein said selected keyer is determined from said state information.

14. A system for keying a media production, comprising:
an input router;
a first keying device for compositing a first keyer layer on the media production to thereby produce a composite media production, wherein said first keying device accesses the media production from said input router; and
a second keying device for compositing a second keyer layer on said composite media production, wherein said second keying device is positioned in series with said first keying device.

15. The system of claim 14, further comprising:
a switcher for receiving said composite media production, wherein said composite media production includes said first keyer layer and said second keyer layer.

16. A system for keying a media production, comprising:
an input router; and
a routing matrix including a plurality of keying devices, wherein each keying device is responsive to receiving a keying command that, when executed, instructs a keying device to key the media production in parallel or in series with another keying device.

17. The system of claim 16, further comprising:
a switcher for receiving the media production from said routing matrix, wherein the media production comprises a layer keyed from said routing matrix.

18. A computer program product comprising a computer useable medium having control logic embedded in said medium for causing a computer to select an available keying device from a plurality of keying devices, said control logic comprising:
first means for causing the computer to monitor state information pertaining to the plurality of keying devices;
second means for causing the computer to detect a keying device having state information indicating that said keying device is not currently operating to produce a preview output or a program output; and
third means for causing the computer to select said keying device detected by said second means as the available keying device, in response to said second means detecting only one keying device having said state information.

19. The computer program product according to claim 18, further comprising:
fourth means for causing the computer to execute a first-in-first-out routine to select the available keying device in response to said second means detecting two or more keying devices having said state information.

20. The computer program product according to claim 18, further comprising:
fourth means for causing the computer to execute a first-in-first-out routine to select a keying device producing a preview output in response to said second means detecting no keying device having said state information.
